(19) United States
(12) Patent Application Publication
(10) Pub. No.: US 2003/0095208 A1
(43) Pub. Date: May 22, 2003

(54) Process for the creation of interactive audiovisual clips

(76) Inventors: Laurent Chouraqui, Paris (FR); Jerome Chouraqui, Paris (FR); Etienne Grange, Paris (FR); Fabien Chancoin, Paris (FR)

Correspondence Address: SCHNADER HARRISON SEGAL & LEWIS, LLP, 1600 MARKET STREET, SUITE 3600, PHILADELPHIA, PA, 19103

(21) Appl. No.: 10/040,696

(22) Filed: Dec. 28, 2001

Related U.S. Application Data
(63) Continuation of application No. PCT/FR00/01836, filed on Jun. 29, 2000.

(51) Int. Cl. H04N 7/025; H04N 7/10; H04N 7/173; H04N 7/16; H04N 7/00; H04N 11/00

(52) U.S. Cl. 348/460; 348/461; 725/32; 725/90; 725/135

(57) ABSTRACT

A process for transmission of a digital televised broadcast including interactive advertisement sequences which can be activated at least in part by a television viewer including transmitting elemental advertisement components materialized in the form of codes calling up native functions, comprising components of “INITIALIZATIONS”defining positioning in a data structure of other components, components of “DRAWS” corresponding to graphic representations materialized in the structure in the form of codes calling up native factions of a host language of a digital terminal, components of “PALETTES” corresponding to color palettes and components of “SCREENS” corresponding to screen descriptions, and constructing an animated image by superposition of an animated image background corresponding to a principal broadcast and an image grouping together at least a part of elemental components by an execution program loaded in the digital terminal.

### RELATED APPLICATION

This is a continuation of International Application No. PCT/FR00/01836, with an international filing date of Jun. 29, 2000, which is based on French Patent Application No. 99/08330, filed Jun. 29, 1999.

### FIELD OF THE APPLICATION

This invention pertains to the field of televised broadcasts and more specifically to televised broadcasts offering interactivity with the television viewer.

### BACKGROUND

Digital television systems require the use of a specific decoder for the visualization of images broadcast by satellite or cable and which decoder comprises software elements. These software elements make it possible to superpose specific informational or advertisement elements on the broadcast image and to implement connections to a database, e.g., via a modem.

A specific display informs the television viewer of the possibility of obtaining complementary information and an action on his part triggers the unfolding of the specific sequence. At that moment, the display of the video stream is stopped: a fixed image in cyclical diffusion on the broadcast signal is loaded and then displayed on the screen. This advertisement image functions as a support for the display of supplementary information in the form of text via the OSD (On Screen Display) circuit of the decoder. This circuit enables display of the text and icons in superimposition of a conventional video stream with the possibility of using transparency colors.

It is also possible to stop the display of the video stream and possibly the audio stream. An advertisement image in cyclical diffusion with the satellite stream is loaded then displayed on the screen. This image functions as background for the supplementary information diffused in the form of text and icons (animated or fixed) and scripted:

The scripts can be linear; a simple succession of information that the television viewer can cause to scroll forward at a selected pace by means of the remote control. This information can also be scripted in questionnaire form, allowing the viewer to participate in contests, to be selected for activities, etc. These scripts are defined with the announcer and are not closed in their evolution.

Nevertheless, programming of the advertisement display applications is tedious: they are often similar and can only be distinguished by the text content and the screen position. This requires multiple trials and recompilations to correctly position the text and the icons. Moreover, the requirement that the program code must be modified for each new advertisement increases the risk of introducing new errors.

Also known is WO 96/34494 which describes a process enabling the delivery of information for a user including confidential or other information sent to a vendor under secure conditions without it being necessary for the user to transmit the information under secure conditions. The user provides a user identifier and information including confidential information to a response collector which establishes the link between the user identifier and the user information. The response collector can verify the information to protect against fraud. An information provider provides an application identifier and vendor routing information to a response collector which establishes the link between the vendor routing information and the application identifier. The application identifier corresponding to the vendor is broadcast to the user by means of an interactive information system application and this interactive information system transmits the application identifier, a user identifier and other response information to a response collector in accordance with instruction from the user and the interactive information system application. The response collector can then deliver the user information and the other response information to the vendor in accordance with the vendor routing information. The user can transmit anonymous responses in the same manner without transmitting the user identifier to the response collector.

### SUMMARY OF THE INVENTION

This invention relates to a process for transmission of a digital televised broadcast including interactive advertisement sequences which can be activated at least in part by a television viewer including transmitting elemental advertisement components materialized in the form of codes calling up native functions, including components of “INITIALIZATIONS” defining positioning in a data structure of other components, components of “DRAWS” corresponding to graphic representations materialized in the structure in the form of codes calling up native factions of a host language of a digital terminal, components of “PALETTES” corresponding to color palettes and components of “SCREENS” corresponding to screen descriptions, and constructing an animated image by superposition of an animated image background corresponding to a principal broadcast and an image grouping together at least a part of elemental components by an execution program loaded in the digital terminal.

This invention also relates to a device for implementation of interactive advertisement sequences including means for displaying original animated images, means for displaying a created advertisement sequence, and an advertisement screen creation interface in which elemental advertisement components are graphically materialized to enable installation of graphic elements to be displayed.

This invention still further relates to a digital decoder for composite video signals including means for separating a video signal from elemental advertisement components, means for storing in memory said elemental components, and means for calculating an image resulting from the combination of the elemental components.

### DETAILED DESCRIPTION

The invention resolves the problems described above by providing a process and a device enabling easy creation of these advertisement sequences. The invention uses graphic tools that provide the possibility of evaluating directly the result of the manipulation of the texts and images on the screen. The invention will be described most specifically for advertisements but its scope extends to all transmissions of visual or graphical elements by a communication means.

Thus, the invention pertains to a process for transmission of a digital televised broadcast comprising interactive advertisement sequences which can be activated at least in part by the television viewer. This process comprises an elemental advertisement component transmission step as well as a step of construction of an animated image by superposition of an animated image background corresponding to the principal broadcast and an image grouping together at least a part of the elemental components.

The weight of the elemental components is advantageously less than about 10,000 octets.

In a preferred manner, the elemental components belonging to predefined classes of graphic elements enabling definition of an image and are stored in memory according to their membership class.

The storing in memory of the elemental components can be performed in a sequential manner in one class or according to their order of use in the construction of the animated images. These two solutions are preferentially combined by storing the elemental components in memory according to their class and sequentially in their class in the order of their use in the construction of the animated images.

In one advantageous variant, the elemental components are displayed by a specific interface present in the digital decoder.

The invention also pertains to a device for implementation of interactive advertisement sequences comprising means for displaying original animated images and means for displaying the created advertisement sequence. It comprises an advertisement screen creation interface in which the elemental advertisement components are graphically materialized to enable installation of the graphic elements to be displayed.

Finally, the invention also pertains to a digital decoder for composite video signals characterized in that it comprises means for separating the video signal from the elemental advertisement components, means for storing in memory said elemental components and means for calculating an image resulting from the combination of said elemental components.

Better comprehension of the invention will be provided by the detailed description below in which a specific software program was created to implement the process according to the invention.

An editor makes it possible to visually and easily create a data file describing the content and the behavior of an interactive advertisement application. An autonomous execution program loaded in the digital terminal recovers the data created by the aforementioned editor and broadcast in the satellite stream. These data are then interpreted by this program to display the advertisement information. The editor is most preferably programmed in a language of the Java (trademark) type which provides the possibility of being exploited on any existing platform integrating a virtual Java engine.

This editor is a visual tool that makes it easy to create different screens, composites of elemental components such as clips, texts, icons, geometric shapes. All of these objects can be easily positioned using “drag-and-drop.” The result is immediately viewable. As a complement to these graphic objects, the editor can assign different stimuli and actions to these screens.

The stimuli include but are not limited to the following:

Pressure on any key of the remote control or the front panel (with option of storing the button in memory in a memory zone to be transmitted via modem. This enables implementation of multiple-choice questionnaires).

Events linked to a clock (with option of the duration of activation of the clock).

Events linked to the end of a connection of the modem.

Beginning of a data capture (with option of the type of data capture: text, date).

End of a data capture.

Top of synchronization.

Each stimulus can trigger at least one of the following actions:

Visualization of any autonomous interactive application enabling, for example, access to a shop.

Visualization of any channel (with the channel number as an option).

Connection of the modem.

Changing of the screen (with option of giving the screen identifier).

Quitting the application.

This set of stimuli and applications enable creation of a navigation path among the screens. All types of navigation can be created. This type of architecture allows for the possibility of creating more complex navigation paths.

The data format is composed of different classes of components or structures. These structures are organized in the following manner:

INITIALIZATIONS

DRAWS
Draw 1
Draw 2
. . .
Draw n
PALETTES
Palette 1
Palette 2
. . .
Palette n
SCREENS
Screen 1
Screen 2
. . .
Screen n

The data enabling the display of an advertisement sequence are organized according to a specific format and comprise all of the data required for the functioning of an application of this type. Each data element that has a visual or auditory effect is considered to be an elemental component. The elemental components requiring a common treatment are grouped together in classes of components. These elemental components comprise the texts, icons, their positioning, the stimuli, the actions, the navigation information and all complementary visual or auditory elements. It is possible to treat the icons as sets comprising more precise elemental components such as the color, shape, geometric lines contained in the icon.

The INITIALIZATIONS comprise the positioning in the data structure of the DRAWS, PALETTES and SCREENS.

The DRAWS are graphic representations: of the text, geometrical shapes, lines, points, color changes, fonts, line thickness. They are materialized in the structure in the form of codes calling on the native functions of the host language of the digital terminal.

The PALETTES are color palettes and define a particular class of elemental components. It is possible to define a single or multiple different palettes for each application. This structure contains the components Red, Green, Blue and Alpha (transparent) for each color of the palette.

The SCREENS are descriptions of screens. These structures are a listing of DRAWS that compose a screen. Moreover, a series of stimuli and actions can be associated with each SCREEN. These elements are also materialized in the form of codes calling up native functions.

A specific program is assigned to recover the structure of the data on the satellite stream in order to interpret it.

After recovering the data, this execution program interprets them. In order to do so, it references the positions of the SCREENS, PALETTES and DRAWS in the INITIALIZATIONS. It then creates the palette with that present in the data. The next step consists of displaying the first screen by default:

Knowing the position of the SCREENS, it references the first of the application, looks at the DRAWS which compose it and display these DRAWS. It then references the stimuli associated with this screen. It then puts itself in a mode of waiting for these screens. When one of the stimuli is detected, the program looks at the action with which it is associated. It executes this action.

In this manner, the application can progress from screen to screen, implementing the various actions explained above. It is thus possible to create complex applications comprising more screens, games, various data captures, modem connections.

1. A process for transmission of a digital televised broadcast comprising interactive advertisement sequences which can be activated at least in part by a television viewer comprising:
transmitting elemental advertisement components materialized in the form of codes calling up native functions, comprising components of “INITIALIZATIONS” defining positioning in a data structure of other components, components of “DRAWS” corresponding to graphic representations materialized in the structure in the form of codes calling up native factions of a host language of a digital terminal, components of “PALETTES” corresponding to color palettes and components of “SCREENS” corresponding to screen descriptions; and
constructing an animated image by superposition of an animated image background corresponding to a principal broadcast and an image grouping together at least a part of elemental components by an execution program loaded in the digital terminal.

2. The process according to claim 1, wherein the weight of the elemental components is less than about 10,000 octets.

3. The process according to claim 1, wherein the elemental components belong to predefined classes of graphic elements enabling definition of an image and said elemental components are stored in memory according to their membership class.

4. The process according to claim 1, wherein the graphic representations are selected from the group consisting of text, geometric shapes, lines, points, color changes, fonts and line thickness.

5. The process according to claim 3, wherein the elemental components are stored in memory sequentially in their class in order of their use in construction of the animated images.

6. The process according to claim 3, wherein display of the elemental components is implemented according to membership classes and according to preselected criteria for each class.

7. The process according to claim 5, wherein display of the elemental components is implemented according to membership classes and according to preselected criteria for each class.

8. The process according to claim 3, wherein the elemental components are displayed by a specific interface in a digital decoder.

9. A device for implementation of interactive advertisement sequences comprising:
means for displaying original animated images;
means for displaying a created advertisement sequence; and
an advertisement screen creation interface in which elemental advertisement components are graphically materialized to enable installation of graphic elements to be displayed.

10. A digital decoder for composite video signals comprising:
means for separating a video signal from elemental advertisement components;
means for storing in memory said elemental components; and
means for calculating an image resulting from the combination of said elemental components.
